(19) United States
(12) Patent Application Publication
(10) Pub. No.: US 2002/0187675 A1
(43) Pub. Date: Dec. 12, 2002

(54) Integrated cord take-up assembly

(76) Inventors: Faris W. McMullin, Boise, ID (US); Edwin L. Wheeler, Boise, ID (US)

Correspondence Address: DYKAS, SHAVER & NIPPER, LLP, PO BOX 877, BOISE, ID, 83701-0877, US

(21) Appl. No.: 10/143,569

(22) Filed: May 8, 2002

Related U.S. Application Data
(60) Provisional application No. 60/289,931, filed on May 9, 2001.

(51) Int. Cl. H01R 13/72

(52) U.S. Cl. 439/501

(57) ABSTRACT

An integrated cord take up assembly and signal transforming device made up of a housing having a transforming circuit and a wire winding means connected therein. The transforming circuit is connected to an input means and an output means and is configured to transform a signal from the input means and to send that signal out through the output means. The input means is connected to a transforming circuit which modifies an input signal from the input means. The transforming circuit then sends out the transformed signal through the output means. A wire connects either the receiver to the input means and/or the out put means to the transformer. The wire is connected to a wire-winding mechanism that is also contained within a housing. The wire winding mechanism is configured to selectively wind and hold the wire within the housing.

### CLAIM OF PRIORITY

This application is a continuation of and claims the priority of U.S. Provisional Application Serial No. 60/289/931 originally filed May 9, 2001.

### BACKGROUND OF THE INVENTION

1. Field of the Invention

The present invention generally relates to an integrated cord take-up assembly and more particularly relates to a cord take-up for use with electronic devices wherein there is an electrical input which is modified and transformed through an electrical circuit, contained within a housing, and outputted through a wire to an output connector wherein said wire is spooled upon a wire take-up device which is also contained within said housing.

2. Background Information

Power adapters for mobile computers, cell phones, game systems, as well as many other applications comprised of an input side DC or AC connection, and/or a transformer, and/or AC to DC electronics, or other appropriate electronics for filtering, etc., and a low voltage DC connection on the output side, have cords for input and output of power. The input side may plug directly from the housing containing the electronics, or it may have a cord terminated with a plug from a few inches to a few feet in length. The output side usually has a cord of several feet in length. These corded systems are very bulky and require substantial storage area. This is difficult to manage. After using these systems one must then wind up and or bind up the cord for storage. This is time consuming and frustrating, usually ending up with tangled cords. The next time the system is used, the cords must be untangled.

What is needed is a method of managing the cords of a system that eliminates the need to manually manage the cords when installing or removing them from the system being used. While a retractor could be made that would be retracted by hand, this is best accomplished by using a spring-loaded retractor.

### SUMMARY OF THE INVENTION

One aspect of the invention is a hand-wound retractor or retractors or a spring loaded retractor or retractors incorporated into a housing which may contain electronics and 20 or a transformer which are terminated on one end by a DC or an AC connection, and terminated -on a second end by a DC connection. Exemplary implementations of the invention are illustrated in the accompanying drawings.

While not all adapters require the use of electronics, usually one or both of the terminations are connected to electronics in the housing using electrical cord. The input 25 side of the retractor may contain a folding plug or adapter for a plug suited for the power connection requirements for the country, or situation, in which the retractor is being used, or it may use a length of cord which is fixed or removable to accomplish the same thing. The input side of the retractor may incorporate a male plug for insertion into an automotive cigarette lighter or vehicle type power supply.

The invention can be used to provide power for immediate use, or can act as a battery charger. This can be accomplished by using electrical cords of a variety of shapes. One specific implementation would be accomplished by using thin flat electrical cord in 5 applications where a cord is required. The thin flat cord is comprised of more than one length of wire lying in parallel and encapsulated in an insulator. This insulator is formed in such a way as to create a flat profile in which the thickness of the cord created is substantially less than the width.

The hand wound retractor is comprised of a winding mechanism connected to a spool that contains the cord and potentially a slip ring assembly, and potentially a ratcheting assembly. The winding mechanism has finger slots or indentations in the exterior of the mechanism by which the force of the fingers could be applied to rotate the mechanism, or it is comprised of a handle which folds into the exterior of the mechanism which can be turned by hand to retract the cord. The slip ring assembly provides a continuous connection from the retractable side to the electronics, and thus to the power supply.

The spring-loaded retractor is comprised of a coiled spring, a spool to contain the cord, and potentially a slip ring assembly, and potentially a ratcheting assembly. The spring is wound into the housing and attached to the spool incorporated in the housing, and provides the tension on the cord when extended to wind the cord back onto the spool. The slip ring assembly provides a continuous connection from the retractable cord to the electronics and thus to the power supply.

The use of a slip ring is one embodiment, but does not preclude other methods of providing a continuous connection. These could include the use of a reservoir of 25 cord, or a rotating connector driven by the spool which contains the cord.

In the spring loaded retractor, the ratcheting assembly provides a method of locking the extendable cord at different lengths by the choice of the user. It also provides a release method to allow the cord to be extended further to its full length or to be retracted into the housing. This is accomplished by pulling on the cord and then releasing the cord. Each alternating time the cord is pulled the ratcheting mechanism will either lock the cord in place at the length it is extended, or it will release the cord to be retracted back onto the spool. The cord can be manually stopped from retracting back onto the spool by putting the cord in tension. By extending the cord again and releasing it, the cord will then lock into place.

One implementation of an adapter for mobile computers, cell phones, and other equipment requiring such adapters, would contain a selector switch and appropriate internal electronics to allow the unit to be used with any of the most popular lap top computers, or cell phones, or other equipment, given that the DC power requirements vary from manufacturer to manufacturer.

Another implementation of an adapter for mobile computers users and cell phone users would contain electronics which would sense input power and output power requirements of the unit in use, and would then automatically switch internally to provide the correct power of the unit in use.

There is a need for managing cords attached to power adapters and chargers. This includes notebook and laptop computers. But other adapters and chargers need cord management as well such as cell phone battery chargers, adapters for games like Nintendo, medical devices and other equipment requiring AC to DC adapters. To help manage the cord from the adapter or charger to the equipment, a cord retractor incorporated in the adapter housing would be a good solution. The basic problem of retracting cords supplied with the adapter or charger is that they are not very flexible and also are round and large in diameter thus making a retractor too large and bulky. A retractor with a thin flat cord having very flexible wires would solve this cord management problem.

A very thin flat cord can be achieved by using multiple flexible wires in a row and connected in parallel to share the current requirement of the cord. This allows a reduction in wire size (versus one wire) thereby allowing the cord thickness to be reduced. This in turn allows more wraps of wire in a given case size or allows the case size to be reduced for a given cord length requirement.

For a notebook computer, an implementation of a power adapter with a ratcheting retractor would be to use a power adapter that would accommodate the power requirements of most of the popular notebook computers and be selectable by using a switch to choose the appropriate notebook computer.

The ratcheting retractor would be housed in the same housing as the AC to DC power adapter. The AC power would come in through an AC plug mounted on the housing or a short cord terminated with the AC plug and the cord entering the housing through a strain relief grommet and soldered to the internal power supply.

The DC output of the power adapter would be connected to the extended end of the retractor. The extended end of the retractor would have a plug that would go to the DC power receptacle in the notebook computer. Suitable connector adapters for each brand of computer would be supplied with each power adapter.

The ratcheting retractor would have a rugged, low cost, user friendly ratcheting mechanism where the ratchet would lock at any number of positions (depending on the number of teeth on the gear) for each revolution of the ratchet gear/extended length of cord and unlock by a small pull of the cord. This ratchet mechanism uses only three parts: a gear, a pawl and a spring. The gear and pawl can be made using many different moldable resins and the spring can be made of metal or molded as part of the pawl. By making the spring as part of the pawl there are only two parts instead of three (i.e.) a very low cost ratchet mechanism.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a top plan view of a first embodiment of the integrated cord take-up assembly;

FIG. 2 is a side view of the first embodiment of the integrated cord take-up assembly;

FIG. 3 is a bottom plan view of the first embodiment of the integrated cord take-up assembly;

FIG. 4 is a top plan view of a second embodiment of an integrated cord take-up assembly; and

FIG. 5 is a side view of the second embodiment of an integrated cord take-up assembly.

### DESCRIPTION OF THE PREFERRED EMBODIMENTS

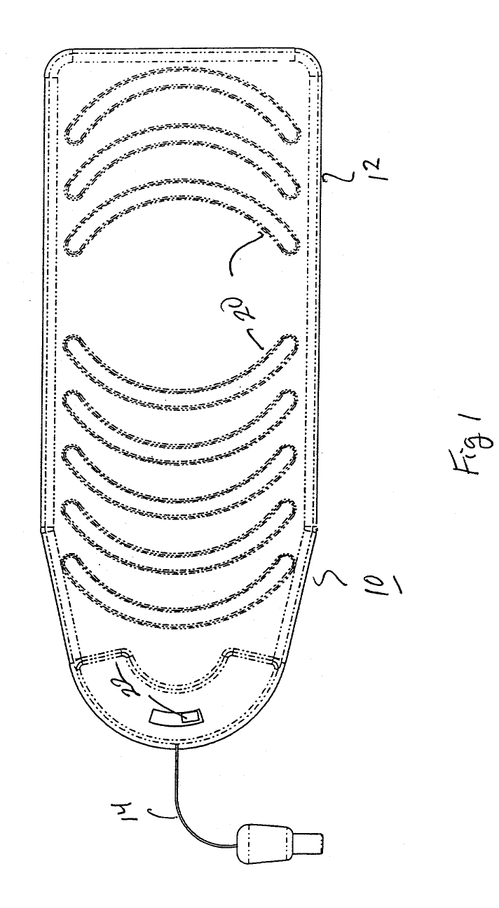

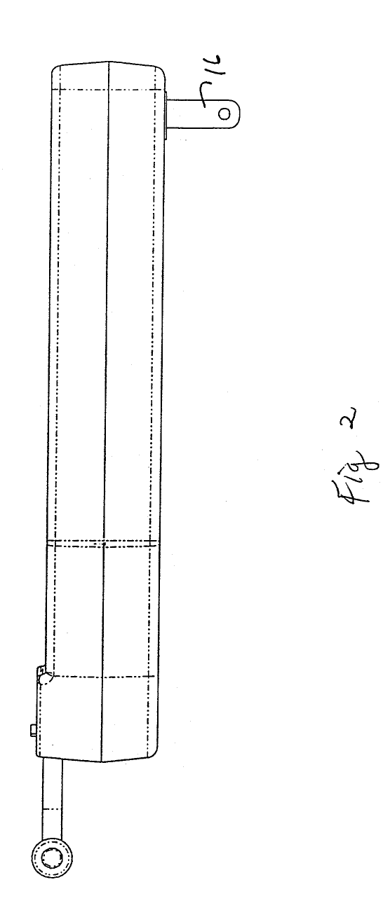

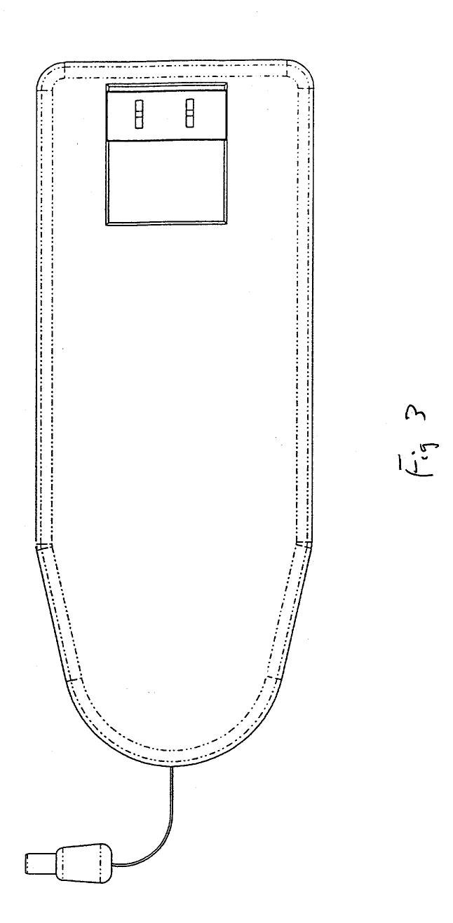

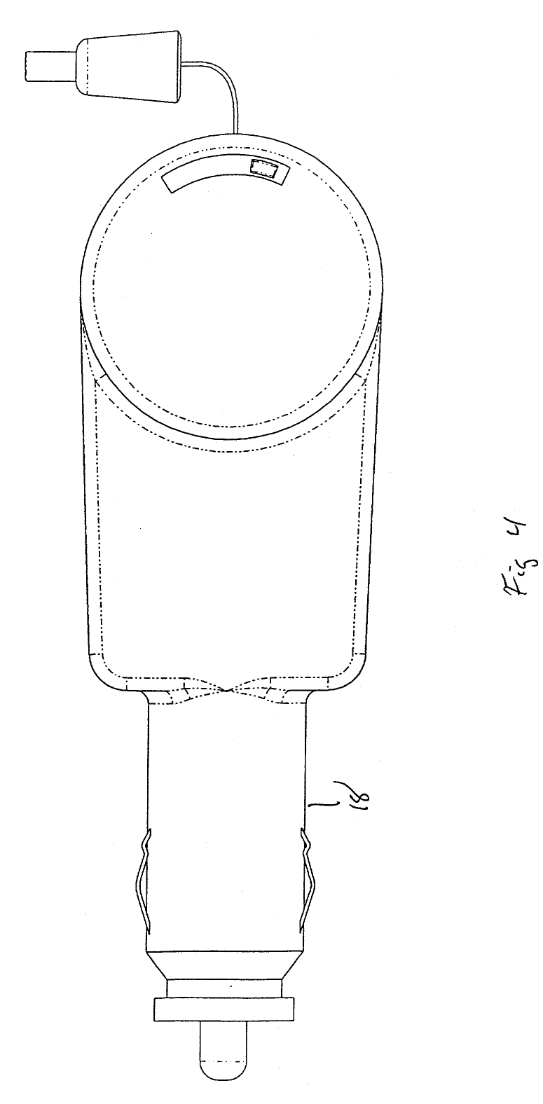

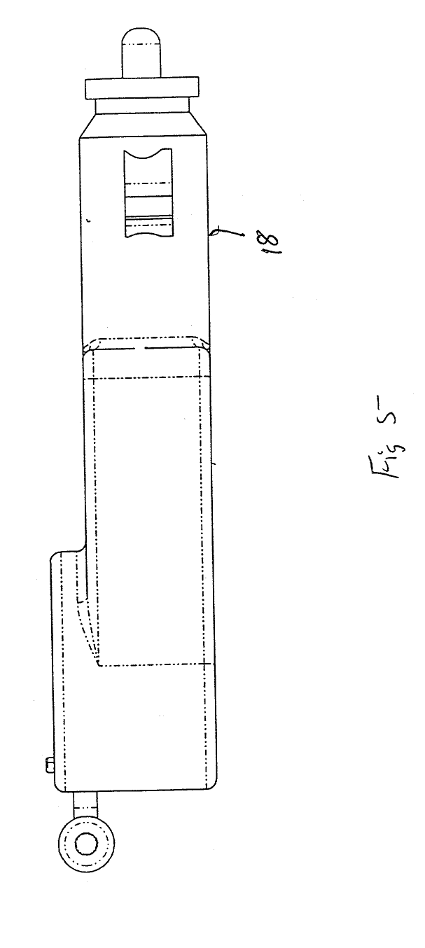

One aspect of the invention is a hand-wound retractor or retractors or a spring loaded retractor or retractors incorporated into a housing which may contain electronics and 20 or a transformer which are terminated on one end by a DC or an AC connection, and terminated on a second end by a DC connection. Exemplary implementations of the invention 10 are illustrated in the accompanying drawings FIGS. 1 through 5.

While not all adapters require the use of electronics, usually one or both of the terminations are connected to electronics in housing 12 using electrical cord 14. The input side of the retractor may contain a folding plug or adapter 16 for a plug suited for the power connection requirements for the country, or situation, in which the retractor is being used, or it may use a length of cord which is fixed or removable to accomplish the same thing. The input side of the retractor may incorporate a male plug 18 for insertion into an automotive cigarette lighter or vehicle type power supply.

The invention can be used to provide power for immediate use, or can act as a battery charger.

This can be accomplished by using electrical cords 14 of a variety of shapes. One specific implementation would be accomplished by using thin flat electrical cord as shown in United States Patent to Petersen et al, U.S. Pat. No. 5,516,986, issued May 14, 1996, the teachings of which are hereby incorporated by reference. The thin flat cord is comprised of more than one length of wire lying in parallel and encapsulated in an insulator. This insulator is formed in such a way as to create a flat profile in which the thickness of the cord created is substantially less than the width.

The hand wound retractor is comprised of a winding mechanism connected to a spool that contains the cord and potentially a slip ring assembly (not shown), and potentially a ratcheting assembly. In the preferred first embodiment, the winding mechanism has finger slots or indentations 20 in the exterior of the mechanism by which the force of the fingers could be applied to rotate the mechanism, or it is comprised of a handle which folds into the exterior of the mechanism which can be turned by hand to retract the cord. The slip ring assembly provides a continuous connection from the retractable side to the electronics, and thus to the power supply.

The spring-loaded retractor is comprised of a coiled spring, a spool to contain the cord, and potentially a slip ring assembly, and potentially a ratcheting assembly. The spring is wound into the housing and attached to the spool incorporated in the housing, and provides the tension on the cord when extended to wind the cord back onto the spool. The slip ring assembly provides a continuous connection from the retractable cord to the electronics and thus to the power supply.

The use of a slip ring is one embodiment, but does not preclude other methods of providing a continuous connection. These could include the use of a reservoir of cord, or a rotating connector driven by the spool which contains the cord.

In the spring loaded retractor, the ratcheting assembly provides a locking device 22 for locking the extendable cord at different lengths by the choice of the user. It also provides a release method to allow the cord to be extended further to its full length or to be retracted into the housing. This is accomplished by pulling on the cord and then releasing the cord. Each alternating time the cord is pulled the ratcheting mechanism will either lock the cord in place at the length it is extended, or it will release the cord to be retracted back onto the spool. The cord can be manually stopped from retracting back onto the spool by putting the cord in tension. By extending the cord again and releasing it, the cord will then lock into place.

One implementation of an adapter for mobile computers, cell phones, and other equipment requiring such adapters, would contain a selector switch and appropriate internal electronics to allow the unit to be used with any of the most popular lap top computers, or cell phones, or other equipment, given that the DC power requirements vary from manufacturer to manufacturer.

Another implementation of an adapter for mobile computers users and cell phone users would contain electronics which would sense input power and output power requirements of the unit in use, and would then automatically switch internally to provide the correct power of the unit in use.

There is a need for managing cords attached to power adapters and chargers. This includes notebook and laptop computers. But other adapters and chargers need cord management as well such as cell phone battery chargers, adapters for games like Nintendo, medical devices and other equipment requiring AC to DC adapters. To help manage the cord from the adapter or charger to the equipment, a cord retractor incorporated in the adapter housing would be a good solution. The basic problem of retracting cords supplied with the adapter or charger is that they are not very flexible and also are round and large in diameter thus making a retractor too large and bulky. A retractor with a thin flat cord having very flexible wires would solve this cord management problem.

A very thin flat cord can be achieved by using multiple flexible wires in a row and connected in parallel to share the current requirement of the cord. This allows a reduction in wire size (versus one wire) thereby allowing the cord thickness to be reduced. This in turn allows more wraps of wire in a given case size or allows the case size to be reduced for a given cord length requirement.

For a notebook computer, an implementation of a power adapter with a ratcheting retractor would be to use a power adapter that would accommodate the power requirements of most of the popular notebook computers and be selectable by using a switch to choose the appropriate notebook computer.

The ratcheting retractor would be housed in the same housing as the AC to DC power adapter. The AC power would come in through an AC plug mounted on the housing or a short cord terminated with the AC plug and the cord entering the housing through a strain relief grommet and soldered to the internal power supply.

The DC output of the power adapter would be connected to the extended end of the retractor. The extended end of the retractor would have a plug that would go to the DC power receptacle in the notebook computer. Suitable connector adapters for each brand of computer would be supplied with each power adapter.

The ratcheting retractor would have a rugged, low cost, user friendly ratcheting mechanism where the ratchet would lock at any number of positions (depending on the number of teeth on the gear) for each revolution of the ratchet gear/extended length of cord and unlock by a small pull of the cord. This ratchet mechanism uses only three parts: a gear, a pawl and a spring. The gear and pawl can be made using many different moldable resins and the spring can be made of metal or molded as part of the pawl. By making the spring as part of the pawl there are only two parts instead of three (i.e.) a very low cost ratchet mechanism.

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

While there is shown and described the present preferred embodiment of the invention, it is to be distinctly understood that this invention is not limited thereto but may be variously embodied to practice within the scope of the following claims.

From the foregoing description, it will be apparent that various changes may be made without departing from the spirit and scope of the invention as defined by the following claims.

I claim:

1. A signal transforming device which comprises:
a housing;
means for receiving an electrical input to be modified;
a signal transforming circuit unit contained within said housing for modifying said input signal to an output signal, said signal transforming circuit connected to a power wire;
means for sending said output signal;
a wire for interconnecting either said means for receiving an electrical input signal or the means for sending the output signal with said signal transforming circuit a wire-winding mechanism contained within said housing for selectively winding and holding said wire within said housing.
